(19) United States
(12) Patent Application Publication
(10) Pub. No.: US 2024/0262223 A1
(43) Pub. Date: Aug. 8, 2024

(54) DIRECT CURRENT FAST CHARGING CONVERTER FOR VEHICLE TRACTION BATTERY

(71) Applicant: FORD GLOBAL TECHNOLOGIES, LLC, Dearborn, MI (US)

(72) Inventors: Baoming GE, Okemos, MI (US); Lihua Chen, Farmington Hills, MI (US)

(21) Appl. No.: 18/164,037

(22) Filed: Feb. 3, 2023

(51) Int. Cl. B60L 53/20; B60L 58/13; B60L 58/21; H02M 3/335

(52) U.S. Cl. CPC B60L 53/20; B60L 58/13; B60L 58/21; H02M 3/3353

(57) ABSTRACT

A vehicle power system has a power converter including a pair of switches and a pair of diodes all connected in series, an inverter, a traction battery including a pair of series connected battery modules collectively electrically connected between, and in parallel with, the power converter and inverter; and a controller. The controller complementarily opens and closes the switches to alternately charge the battery modules with direct current such that a magnitude of current input to the power converter remains constant.

### TECHNICAL FIELD

This disclosure relates to automotive power systems.

### BACKGROUND

An electrified vehicle may include a traction battery and an electric machine. Electric power from the traction battery may be supplied to the electric machine. The electric machine may convert the electric power to mechanical power to propel the vehicle.

The traction battery may be charged with electric power from a charge station. Depending on the charge station, it may output alternating current or direct current. A cord set is sometimes used to connect the charge station and vehicle via a plug.

### SUMMARY

A power system for a vehicle has a power converter including a pair of switches and a pair of diodes all connected in series, an inverter, a traction battery including a pair of series connected battery modules collectively electrically connected between, and in parallel with, the power converter and inverter, and a controller. The controller is programmed to maintain the switches open to charge the battery modules at a same time with direct current, and to complementarily open and close the switches to alternately charge the battery modules with direct current such that a magnitude of current input to the power converter remains constant.

A method includes generating, by a controller, a first command to maintain a pair of series connected switches of a power converter open to charge at a same time a pair of series connected battery modules that are electrically connected between, and in parallel with, the power converter and an inverter with direct current. The switches and battery modules share a common node. The method also includes generating, by the controller, a second command to complementarily open and close the switches to alternately charge the battery modules via a corresponding diode with direct current such that a magnitude of current input to the power converter remains constant.

A power system for a vehicle has a power converter including a pair of switches and a pair of diodes all connected in series such that the switches are electrically between the diodes, and defining a pair of inputs each connected with a terminal of one of the switches and configured to be connected with a battery charger such that, when connected, the switches and battery charger are in parallel. The power system also has an inverter, a traction battery including a pair of series connected battery modules collectively electrically connected between, and in parallel with, the power converter and inverter, and a controller. The switches and battery modules share a common node. The controller is programmed to complementarily open and close the switches to alternately charge the battery modules with direct current such that a magnitude of current at the inputs remains constant.

### BRIEF DESCRIPTION OF THE DRAWINGS

FIG. 1 is a schematic diagram of a direct current charge station and vehicle with a typical power converter.

FIG. 2 is a schematic diagram of a direct current charge station and vehicle with a proposed power converter.

FIG. 3 shows traces of example complementary switching commands versus time for the switches of FIG. 2.

FIG. 4A shows a trace of charger current versus time for the direct current fast charger of FIG. 2.

FIG. 4B shows traces of module current versus time for the battery modules of FIG. 2.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Some battery electric vehicles use an 800V direct current (DC) bus and an 800V traction battery. This requires an 800V DC fast charger. 400V and 800V DC fast chargers are both available. The 400V DC fast charger is more prevalent in the market, and is expected to still be roughly a third of the market by 2026.

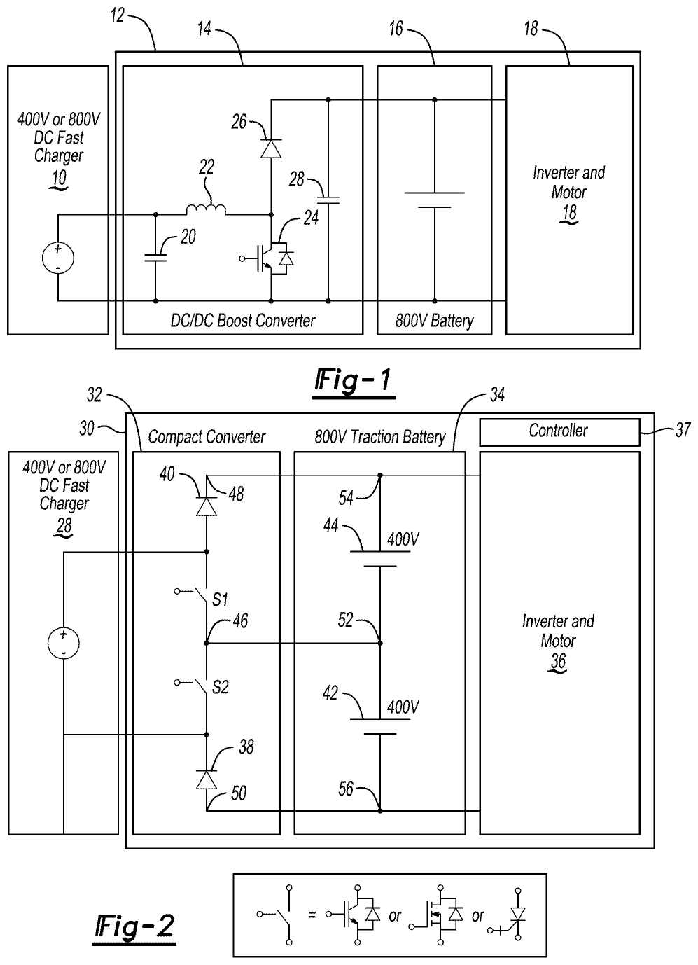

It may be useful to charge an 800V traction battery with either a 400V or 800V DC fast charger. One solution employs a typical DC/DC boost converter. Referring to FIG. 1, a DC fast charger 10 (e.g., 400V or 800V) is electrically connected with a vehicle 12. The vehicle 12 includes a DC/DC boost converter 14, an 800V battery 16, and an inverter and motor 18. The inverter and motor 18 may be used to convert electric power from the 800V battery 16 to mechanical power to move the vehicle 12. The 800V battery 12 is electrically between the DC/DC boost converter 14 and inverter and motor 18.

The DC/DC boost converter 14 includes an input capacitor 20, an inductor 22, a switch 24, a diode 26, and a link capacitor 28. The input capacitor 20 is in parallel with the DC fast charger 10. The inductor 22 shares a terminal with the input capacitor 20, and shares a terminal with the switch 24 and diode 26. The switch 24 and diode 26 are in series, and collectively in parallel with the link capacitor 28.

When the DC fast charger 10 is a 400V DC fast charger, the DC/DC boost converter 14 operates in voltage boost mode to charge the 800V battery 16. When the DC fast charger 10 is an 800V DC fast charger, the DC/DC boost converter 14 operates in passthrough mode to directly charge the 800V battery 16. As apparent from the figure however, the DC/DC boost converter 14 includes the components previously mentioned. These components may be associated with losses and occupy packaging space. Depending on the specific implementation, the input capacitor 20 and link capacitor 28 can be relatively heavy, and the switch 24 needs to be cycled during boost mode, which can be associated with losses and electromagnetic interference. Moreover, the capacitors 20, 28, inductor 22, and other components may need to be cooled during operation. Such circumstances may present efficiency challenges.

Here, a new architecture to facilitate 800V DC fast charging with either a 400V or 800V DC fast charger is presented. This may overcome the above-mentioned issues in forms that may be compact and/or highly efficient.

Referring to FIG. 2, a DC fast charger 28 (e.g., 400V or 800V) is electrically connected with a vehicle 30. The vehicle 30 includes a converter 32, an 800V battery 34, an inverter and motor 36, and a controller 37. The inverter and motor 36 may be used to convert electric power from the 800V battery 34 to mechanical power to move the vehicle 30. The 800V battery 34 is electrically between the DC/DC boost converter 32 and inverter and motor 36. The controller 37 is in communication with and/or exerts control over (e.g., generates commands for) the converter 32, 800V battery 34, and inverter and motor 36.

The converter 32 includes switches S1, S2 and diodes 38, 40, which are connected in series. The switches can be insulated-gate bipolar transistors, metal-oxide-semiconductor field-effect transistors, or gate turn-off thyristors. Outer terminals of the switches S1, S2 define inputs for the converter 32. When connected, the DC fast charger 28 is in parallel with the switches S1, S2. The 800V battery 34 includes a pair of 400V modules 42, 44, which are connected in series. The diode 38 and switch S2 are in parallel with the 400V module 42. The switch S1 and diode 40 a are in parallel with the 400V module 44. That is, the converter 32 has a center tap terminal 46 between the switches S1, S2, a positive DC bus terminal 48, and a negative DC bus terminal 50. And the 800V battery 34 has a center tap terminal 52 between the 400V modules 42, 44, a positive DC bus terminal 54, and a negative DC bus terminal 56. The terminals 46, 52 are directly electrically connected to form a common node. The terminals 48, 54 are directly electrically connected. The terminals 50, 56 are directly electrically connected.

When the DC fast charger 28 is an 800V DC fast charger, the controller 37 turns the switches S1 and S2 off. The 800V DC fast charger 28 directly charges the 800V battery 34 through the diodes 38, 40.

Common communication techniques can be used by the DC fast charger 28 and controller 37 to establish whether the DC fast charger 28 is an 800V DC fast charger or a 400V DC fast charger. The DC fast charger 28, for example, may forward a message (wired or wirelessly) to the controller 37 that identifies the capabilities of the DC fast charger 28.

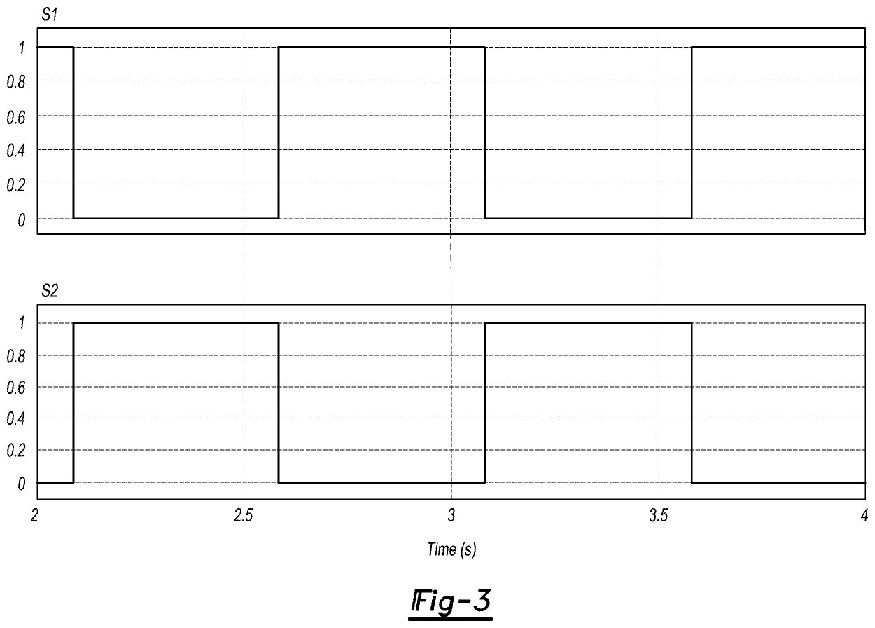

When the DC fast charger 28 is a 400V DC fast charger, the controller 37 operates the switches S1, S2 in complementary fashion. Referring to FIG. 3, the controller 37 operates the switches S1, S2 with a switching frequency f_{sw} to charge the 800V battery 34. The control signals for the switches S1, S2 in this example are such that f_{sw}=1 Hz with a duty cycle of 50%. The switching frequency f_{sw}, however, can be less than 1 Hz or much higher (and the duty cycle may be different) as design and operating conditions dictate.

The switching frequency f_{sw} defines the frequency to charge the 400V modules 42, 44. When the switch S1 is ON (the switch S2 is OFF), the 400V DC fast charger 28 charges the 400V module 42. When the switch S2 is ON (the switch S1 is OFF), the 400V DC fast charger charges the 400V module 44.

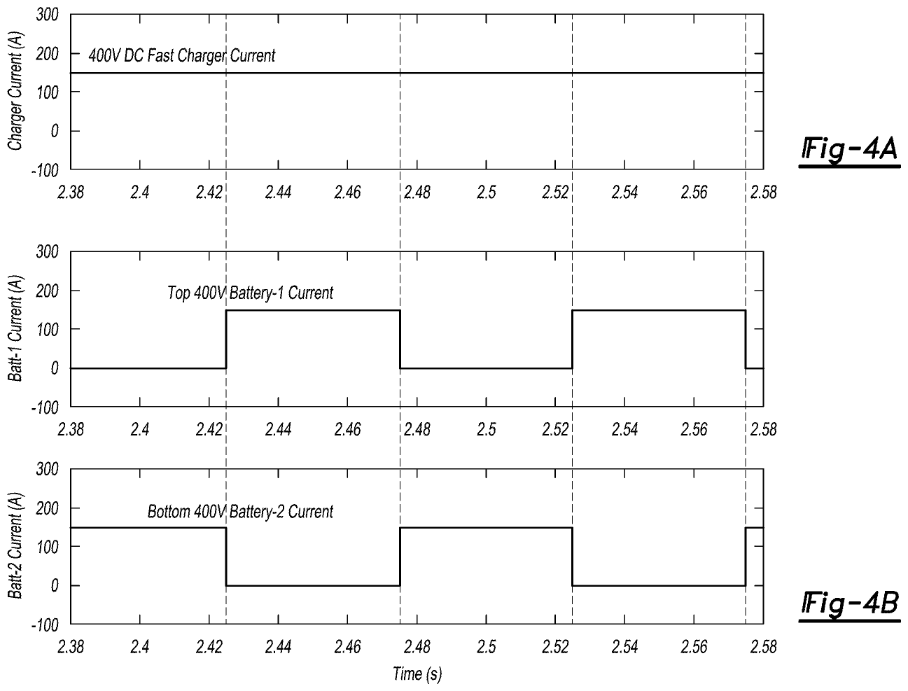

Referring to FIG. 4A, the 400V DC fast charger current magnitude is always constant, and alternately charging the 400V modules 42, 44 has no effect on the operation of the 400V DC fast charger 28.

Referring to FIG. 4B, the time duration and current value to charge the 400V module 42 is equal to the time duration and current value to charge the 400V module 44. That is, the 400V modules 42, 44 have the same status and are well balanced.

If the switching frequency is kept low, the switches S1, S2 can be activated with slow switching speed. As a result, power loss of the switches S1, S2 would be low. The efficiency of the converter 32, in certain implementations, could thus be higher than 99.5%. Moreover, concerns with electromagnetic interference and electromagnetic capability may not be present.

The conventional DC fast charging (same time or sequential) of individual modules of a high voltage battery system would affect operation of the DC fast charger. Moreover, contactors are not able to meet the above-described performance attributes because their switching speeds and response times are too slow and not precisely controlled, which make them difficult to manage. As a result, current commutation facilitated by contactors would affect 400V DC fast charger operation, and the associated 400V DC fast charger current would be interrupted frequently. This would also make it difficult to maintain balance of the 400V modules 42, 44.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The terms “controller” and “controllers,” for example, can be used interchangeably herein.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A power system for a vehicle comprising:
a power converter including a pair of switches and a pair of diodes all connected in series;
an inverter;
a traction battery including a pair of series connected battery modules collectively electrically connected between, and in parallel with, the power converter and inverter; and
a controller programmed to maintain the switches open to charge the battery modules at a same time with direct current, and to complementarily open and close the switches to alternately charge the battery modules with direct current such that a magnitude of current input to the power converter remains constant.

2. The power system of claim 1, wherein one of the switches and one of the diodes are in parallel with one of the battery modules.

3. The power system of claim 1, wherein the switches are collectively electrically connected between the diodes.

4. The power system of claim 1, wherein the switches and the battery modules share a common node.

5. The power system of claim 1, wherein the switches, when connected with a battery charger, are in parallel with the battery charger.

6. The power system of claim 1, wherein the switches are insulated-gate bipolar transistors, metal-oxide-semiconductor field-effect transistors, or gate turn-off thyristors.

7. The power system of claim 1, wherein the battery modules are 400V battery modules.

8. The power system of claim 1 further comprising a motor electrically connected with the traction battery via the inverter.

9. A method comprising:
generating, by a controller, a first command to maintain a pair of series connected switches of a power converter open to charge at a same time a pair of series connected battery modules that are electrically connected between, and in parallel with, the power converter and an inverter with direct current, wherein the switches and battery modules share a common node; and
generating, by the controller, a second command to complementarily open and close the switches to alternately charge the battery modules via a corresponding diode with direct current such that a magnitude of current input to the power converter remains constant.

10. The method of claim 9, wherein the switches are insulated-gate bipolar transistors, metal-oxide-semiconductor field-effect transistors, or gate turn-off thyristors.

11. The method of claim 9, wherein the battery modules are 400V battery modules.

12. A power system for a vehicle comprising:
a power converter (i) including a pair of switches and a pair of diodes all connected in series such that the switches are electrically between the diodes and (ii) defining a pair of inputs each connected with a terminal of one of the switches and configured to be connected with a battery charger such that, when connected, the switches and battery charger are in parallel;
an inverter;
a traction battery including a pair of series connected battery modules collectively electrically connected between, and in parallel with, the power converter and inverter, wherein the switches and battery modules share a common node; and
a controller programmed to complementarily open and close the switches to alternately charge the battery modules with direct current such that a magnitude of current at the inputs remains constant.

13. The power system of claim 12, wherein the controller is further programmed to maintain the switches open to charge the battery modules at a same time with direct current.

14. The power system of claim 12, wherein one of the switches and one of the diodes are in parallel with one of the battery modules.

15. The power system of claim 12, wherein the switches are insulated-gate bipolar transistors, metal-oxide-semiconductor field-effect transistors, or gate turn-off thyristors.

16. The power system of claim 12, wherein the battery modules are 400V battery modules.

17. The power system of claim 12 further comprising a motor electrically connected with the traction battery via the inverter.
